(19) United States
(12) Patent Application Publication
(10) Pub. No.: US 2005/0289488 A1
(43) Pub. Date: Dec. 29, 2005

(54) System and method for mask defect detection

(76) Inventors: I-Ju Chou, Keelung City (TW); Chih-Tung Hsu, Jhubei City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/879,862

(22) Filed: Jun. 29, 2004

(51) Int. Cl. G06F 17/50; G06K 9/00

(52) U.S. Cl. 716/4; 716/19; 382/144

(57) ABSTRACT

A mask defect detection system. The mask defect detection system comprises a first processing device, a second processing device, a third processing device, and a storage device. The first processing device processes mask design information to generate first writer-formatted mask information, wherein the first processing device comprises a first processing module. The second processing device processes mask design information to generate second writer-formatted mask information. The third processing device compares the first and second writer-formatted mask information to find differences therebetween. The storage device stores the mask design information, and the first and second writer-formatted mask information.

### BACKGROUND

The present invention relates to mask defect detection and particularly to a system capable of detecting defects prior to exposure is performed.

Conventionally, defects in a mask are detected after exposure process. Die-to-die and die-to-database inspection methods are the most commonly utilized defect detection methods.

A die-to-die inspection system compares adjacent die patterns. When adjacent die patterns do not match, a discrepancy is registered. After the inspection is completed, an operator must view each discrepancy and determine which kind of defect was detected and assign a code number or classification.

A die-to-database inspection system compares a die to mask data in a database. This inspection ensures that the geometry on the mask matches customer design. A left objective of the inspection system is turned off, and an image in a right objective is compared to preset mask data. When the image does not match the preset mask data, a discrepancy is registered. Again when the inspection is complete, an operator must review each discrepancy and classify it.

The conventional defect detection system, however, presents several disadvantages.

First, the conventional systems cannot detect defects in mask information prior to exposure. Both die-to-die and die-to-database inspection methods process post-exposure masks. Therefore, neither die-to-die nor die-to-database inspection detects defects on a mask prior to exposure. Repair of defects on a post-exposure mask is more difficult than on writer-formatted mask information prior to exposure.

Second, conventional systems cannot detect defects resulting from erroneous mask data preparation. The die-to-die inspection method detects defects by comparing similar die patterns in a particular mask. When defective writer-formatted mask information is employed in exposure, patterns with the same defect are produced. The die-to-die inspection method cannot detect defects appearing repeatedly in each pattern. The die-to-database inspection method detects defects by comparing a die to mask information in a database. When defective writer-formatted mask information is employed in exposure, patterns with the same defect are produced. The defective writer-formatted mask information is stored in a database and serves as a reference in the die-to-database comparison. Therefore, the die-to-database cannot detect defects originating from defective writer-formatted mask information.

Hence, there is a need for a defect detection system that addresses the inefficiency arising from the existing technology.

### SUMMARY

It is therefore an object of the invention to provide a system and method of mask defect detection prior to exposure.

It is another object of the invention to provide a system and method of mask defect detection locating defects in writer-formatted mask information.

According to the invention, a mask defect detection system is provided within a mask fabrication system. The mask defect detection system comprises a first processing device, a second processing device, a third processing device, and a storage device.

The first processing device processes mask design information to generate first writer-formatted mask information, wherein the first processing device comprises a first processing module. The second processing device processes mask design information to generate second writer-formatted mask information, and comprises a second processing module, a non-identical counterpart of the first processing module. The third processing device compares the first and second writer-formatted mask information to identify differences therebetween. The storage device stores the mask design information and the first and second writer-formatted mask information.

The invention also provides a method for mask defect detection implemented in a mask fabrication system. The method detects defects in writer-formatted mask information by comparing writer-formatted mask information generated by different tools. First, mask design information is provided. Next, a first process is performed to convert the mask design information to first writer-formatted mask information. Meanwhile, a second process is performed to convert the mask design information to second writer-formatted mask information. The first writer-formatted mask information and second writer-formatted mask information are then compared to identify differences therebetween. When the comparison is complete, each discrepancy is reviewed and classified.

The above-mentioned method may take the form of program code embodied in a tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram showing a mask defect detection system according to the present invention;

FIG. 2 is a flowchart of the mask defect detection method according to the present invention;

FIG. 3 is a flowchart of a detailed operation example of the mask defect detection method according to the embodiment of the present invention; and

FIG. 4 is a diagram of a storage medium storing a computer program providing the mask defect detection method of the present invention.

### DETAILED DESCRIPTION

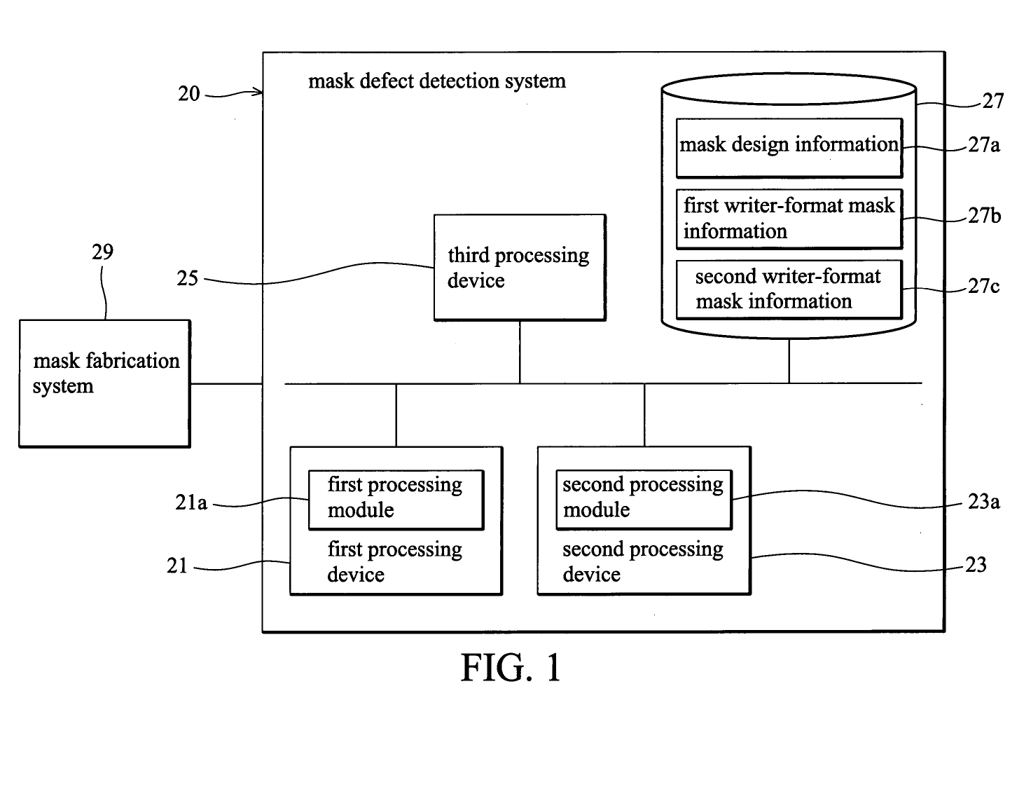

The present invention is now described with reference to FIGS. 1 to 4, which in general relate to a mask defect detection system within a mask fabrication system.

FIG. 1 is a block diagram showing a mask defect detection system according to the present invention. A mask defect detection system 20 is implemented within a mask fabrication system 29, and comprises a first processing device 21, a second processing device 23, a third processing device 25, and a storage device 27.

The storage device 27 stores mask design information 27a, provided in advance.

The first processing device 21 processes the mask design information 27a to generate first writer-formatted mask information 27b, also stored in the storage device 27. The first processing device 21 comprises at least one processing module, such as processing module 21a. The second processing device 23 processes mask design information 27a to generate second writer-formatted mask information 27c, again stored in the storage device 27. The second processing device 23 comprises at least one second processing module, such as a second processing module 23a. The second processing module 23a is a non-identical counterpart of the first processing module 21a. The first and second processing modules accomplish similar functions through different means. The third processing device 25 compares the first and second writer-formatted mask information 27b and 27c to identify differences therebetween. Because first and second writer-formatted mask information 27b and 27c are derived from the same mask design information 27a, any differences therebetween indicate likely errors in data preparation. The differences are then reviewed to confirm the presence of any defects in the writer-formatted mask information.

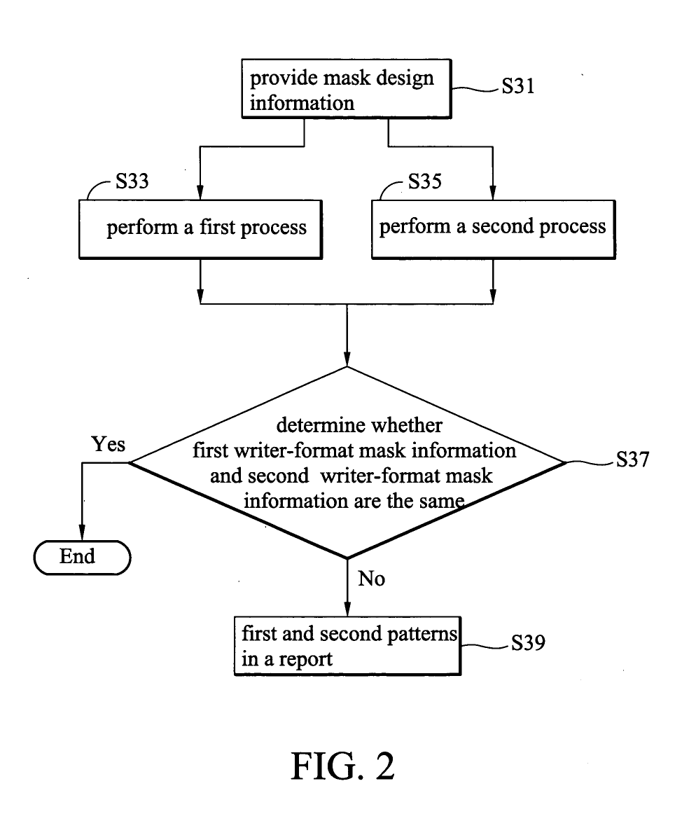

FIG. 2 is a flowchart showing the operation of the mask defect detection method of the present invention. The mask defect detection method shown in FIG. 2 compares writer-formatted mask information generated from the same mask design information using different processing tools. Differences in the writer-formatted mask information indicate potential defects in the writer-formatted mask information occurring in the data preparation stage.

Referring to FIG. 2, mask design information is provided in step S31, conforming to GDS II™ format, generally provided by an IC designer. A first process is then performed to convert the mask design information to first writer-formatted mask information (step S33). Meanwhile, a second process is performed to convert the mask design information to second writer-formatted mask information (step S35). The first writer-formatted mask information and second writer-formatted mask information are then compared to identify differences therebetween (step S37). The differences are then presented in a report (step s39).

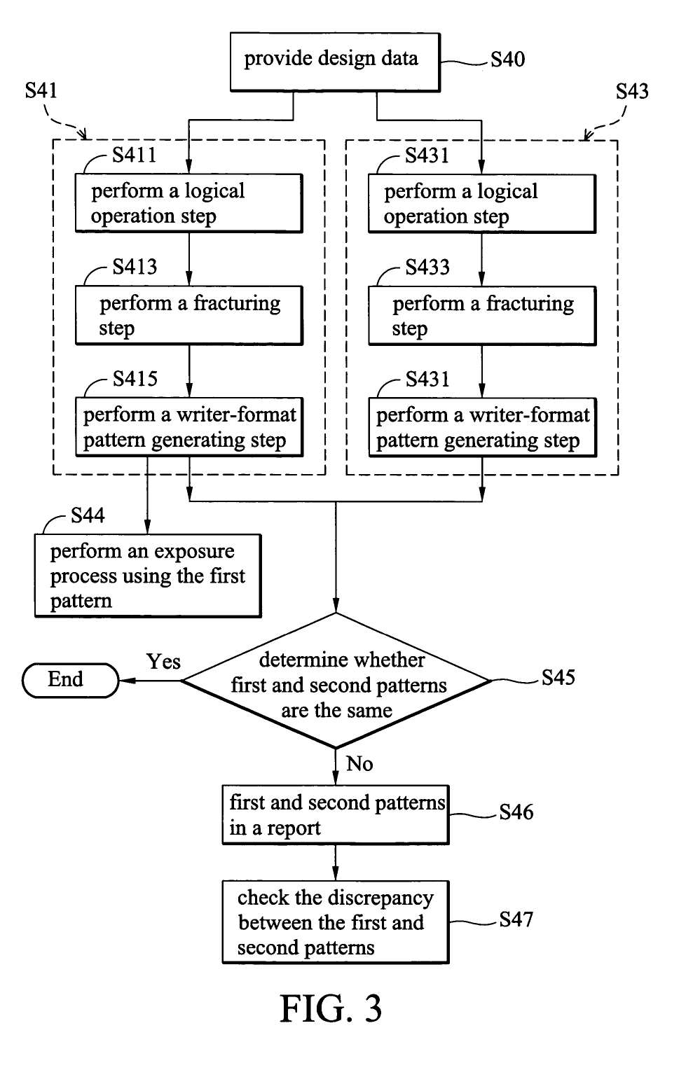

As shown in FIG. 3, a detailed operating example of the present invention, design data (CIF™, Applicon™, DXF™, GDS-II™, or OASIS) is provided in step S40. The design data is generally provided by an IC designer via Internet, and undergoes data preparation processes S41 and S43 performed by two different tool sets, respectively. The data preparation processes S41 and S43 comprise mainly 3 steps, logical operation steps S411 and S431, fracturing steps S413 and S433, and writer-format pattern generating steps S415 and S435. The tools used in steps S411 and S431 perform logical operation functions using different methods. For example, logical operation step S411 is performed by CATS™, while the counterpart step, logical operation step S431, is performed by Hercules™. Similarly, the tools used in steps S413 and S433 perform fracturing functions using different methods. For example, fracturing step S413 is performed by CATS™, while the counterpart step, fracturing step S433, is performed by MaskRigger™. Similarly, the tools used in steps S415 and S435 accomplish writer-format pattern generation through different methods. For example, step S415 is performed by CATS™, while the counterpart step, fracturing step S435, is performed by MaskRigger™. Tools used to perform data preparation processes S41 and S43 are not restricted, provided the sets employed are not the same.

Data preparation processes S41 and S43 convert the design data into a first pattern and second pattern, respectively. The first pattern is then used for exposure (step S44). The first and second patterns are then compared to identify differences therebetween (step S45). When the first pattern and the second pattern are not the same, the differences therebetween are then presented in a diagnostic report (step s46). The discrepancy between the first and second patterns is then checked (step S47).

The method of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

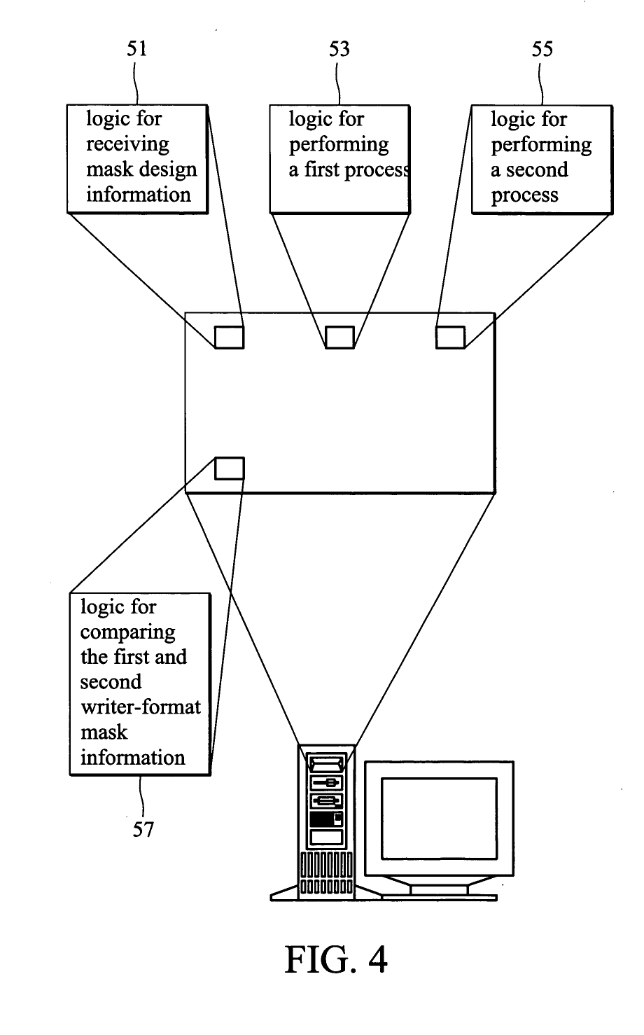

FIG. 4 is a diagram of a storage medium storing a computer program providing a mask defect detection method according to the present invention. The computer program product comprises a computer usable storage medium having computer readable program code embodied therein, comprising computer readable program code 51 receiving mask design information, computer readable program code 53 performing a first process to convert the mask design information into first writer-formatted mask information, computer readable program code 55 performing a second process to convert the mask design information into second writer-formatted mask information, and computer readable program code 57 comparing the first and second writer-formatted mask information to find differences therebetween.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A mask defect detection system, comprising:
a first processing device, converting mask design information into first writer-formatted mask information, wherein the first processing device comprises a first processing module;
a second processing device, converting the mask design information into second writer-formatted mask information, wherein the second processing device comprises a second processing module, a non-identical counterpart of the first processing module;
a third processing device, comparing the first and second writer-formatted mask information to identify differences therebetween; and
a storage device, storing the mask design information and the first and second writer-formatted mask information.

2. The system of claim 1, wherein the first processing module performs a logical operation process.

3. The system of claim 1, wherein the first module performs a fracturing process.

4. The system of claim 1, wherein the first module performs a writer-format pattern generating process.

5. The system of claim 1, further comprising a report generating device, connected to the third processing device, generating a report presenting the identified differences between the first and second writer-formatted mask information.

6. The system of claim 1, further comprising an output device displaying the identified differences.

7. A mask defect detection method, comprising:
providing mask design information;
performing a first process to convert the mask design information into first writer-formatted mask information, wherein the first process comprises a first step;
performing a second process to convert the mask design information into second writer-formatted mask information, wherein the second process comprises a second step, a non-identical counterpart of the first step; and
comparing the first and second writer-formatted mask information to identify differences therebetween.

8. The method of claim 7, wherein the first step performs a logical operation process.

9. The method of claim 7, wherein the first step performs a fracturing process.

10. The method of claim 7, wherein the first step performs a writer-format pattern generating process.

11. The method of claim 7, further generating a report presenting the identified differences between the first and second writer-formatted mask information.

12. The method of claim 7, further displaying the identified differences through an output device.

13. A computer readable storage medium storing a computer program providing a mask defect detection method, the method comprising:
receiving mask design information;
performing a first process to convert the mask design information into first writer-formatted mask information, wherein the first process comprises a first step;
performing a second process to convert the mask design information into second writer-formatted mask information, wherein the second process comprises a second step, a non-identical counterpart of the first step; and
comparing the first and second writer-formatted mask information to identify differences therebetween.

14. The storage medium of claim 13, wherein the first step performs a logical operation process.

15. The storage medium of claim 13, wherein the first step performs a fracturing process.

16. The storage medium of claim 13, wherein the first step performs a writer-format pattern generating process.

17. The storage medium of claim 13, wherein the method further generates a report presenting the identified differences between the first and second writer-formatted mask information.
